(19) United States
(12) Patent Application Publication
(10) Pub. No.: US 2004/0265570 A1
(43) Pub. Date: Dec. 30, 2004

(54) Vertical magnetic recording medium, its manufacturing method and apparatus, and magnetic recording apparatus

(76) Inventors: Migaku Takahashi, Sendai-shi (JP); Shin Saito, Sendai-shi (JP); David Djayaprawira, Sendai-shi (JP)

Correspondence Address: YOUNG & THOMPSON, 745 SOUTH 23RD STREET, 2ND FLOOR, ARLINGTON, VA, 22202, US

(21) Appl. No.: 10/490,282

(22) PCT Filed: Sep. 20, 2002
(86) PCT No.: PCT/JP02/09693

(30) Foreign Application Priority Data
Sep. 21, 2001 (JP) 2001-288835

(51) Int. Cl. B32B 5/16

(52) U.S. Cl. 428/328; 428/337

(57) ABSTRACT

A vertical magnetic recording medium enabling information recording/reproduction with high-recording density and having a soft magnetic backing layer that enables low-noise recording, can be thin, and is excellent in corrosion resistance and its manufacturing method are disclosed. The vertical magnetic recording medium (10) having a soft magnetic backing layer (12) and a vertical recording layer (12) as to serve as a main recording layer and having an easy-magnetization axis mainly oriented vertically to the film surface is characterized in that the soft magnetic backing layer (12) characterized by being made of a soft magnetic material having a composition of FeTaN.

### TECHNICAL FIELD

The present invention relates to a perpendicular magnetic recording medium, the method and apparatus for producing the same and a magnetic recording apparatus, and more specifically to the construction of a perpendicular magnetic recording medium capable of realizing a particularly outstanding recording and reproducing property and the method of producing the same.

The perpendicular magnetic recording medium related to this invention is suitably used for hard disks and magnetic tapes.

### BACKGROUND ART

The magnetic recording media used in the current hard disc drives (HDD) and other magnetic recording apparatuses adopt the longitudinal recording method by which the magnetization direction is fixed in the in-plane direction of magnetic recording and data are recorded by reversing this magnetization. In order to increase the recording density per unit area by this method, efforts have been made to develop recording media that allow mainly shortening the length of magnetization reversal, or improvement of linear recording density.

Up to now, it has been known that an effective method of improving the linear recording density of longitudinal recording media (hereinafter referred to as “in-plane media”) is to shorten the length of magnetization reversal. And in order to address to this problem, the medium is required to have a greater coercivity of the ferromagnetic layer, a lower residual flux density and a reduced thickness of the ferromagnetic layer.

However, any reduction in the thickness of the ferromagnetic layer for the purpose of improving linear recording density tend to result in smaller sizes of crystal grains that constitute the ferromagnetic layer and reduction of their volume V. And when KᵤV, the product of the anisotropy constant Kᵤ of the magnetic crystal grain multiplied by its volume becomes smaller than a certain level, it is feared that under the impact of heat the magnetizing orientation of magnetic crystal grains would become unstable leading to the development of a thermomagnetic relaxation phenomenon and therefore the problem of so-called thermal decay.

Since the smaller the volume V of the crystal grain becomes this problem is all the more apparent, there is a mounting expectation for the development of a magnetic material having a high Kᵤ value to maintain the thermal stability of recording magnetization. To respond to this expectation, the inventor of the present invention disclosed in Japanese Patent Application 11-135038 (WO00/70106) that a CoCrGe ferromagnetic metallic material of a prescribed distribution can realize a high Kᵤ value. And the inventor of the present invention found that thermal decay can be suppressed by reducing the particle size dispersion of crystal grains and disclosed in Japanese Patent Application 11-150424 (WO00/74042) that a magnetic recording medium provided with a seed layer consisting of W or WCr is promising as a concrete means of realizing this.

On the other hand, the perpendicular recording method wherein data are recorded by reversing magnetization in the perpendicular direction to the in-plane of magnetic medium is advantageous in that magnetization does not meet face to face as in the in-plane medium. In other words, even if the size of crystal grains of the ferromagnetic layer is reduced, it is possible to maintain the volume V of crystal grains in the thickness direction by maintaining an appropriate thickness and therefore it will be easy to maintain the thermal stability in the magnetizing direction of magnetic grains. For this reason, the perpendicular recording method is attracting attention as a technology capable of avoiding the problem of thermal decay the outbreak of which is feared in the longitudinal recording method.

As a perpendicular magnetic recording medium applied to such perpendicular recording method, a double-layer film medium comprising a soft magnetic film made of FeNi and other materials easily magnetizable in the in-plane direction between the substratum and the perpendicular recording layer has been proposed. (S. Iwasaki, Y. Nakamura and K. Ouchi: IEEE Trans. Magn. MAG—15 (1979) 1456).

As a result of an analysis by means of the finite elements method of the flow of magnetic flux at the time of recording and reproduction, it was found that the double-layer film medium consisting of a soft magnetic film and a perpendicular recording layer allows writing on the perpendicular recording layer having a stronger coercive force in comparison with the single layer recording medium consisting of only a perpendicular recording medium, and results in an increased reproduction voltage and also in an increased magnetic field in the neighborhood of the main magnetic pole because the presence of this soft magnetic film leads to the convergence at a high density of the magnetic flux originating from the main magnetic pole of the magnetic head in the space at the top of the main magnetic pole. (Shunichi Iwasaki and Shinji Tanabe: Journal of the Institute of Electronics, Information and Communication Engineers J66-C (1983) 740).

In such double-layer film media, permalloy crystalline materials or CoZrNb and other amorphous materials have been used for the soft magnetic film. The permalloy crystalline materials had a problem in that the structure factor S serving as the index of dispersion (skew) of local magnetization is extremely small and therefore a large number of 180° domain walls are formed within the soft magnetic film. And the magnetic flux leakage from these domain walls resulted in frequent spike noises. In addition, the crystalline sputtering film had a problem in that the surface of thin films becomes rough due to the initial island growth mode of crystal grains and low-frequency noises occur due to the magnetic flux leakage from magnetic pole resulting from this rough part. On the other hand, the soft magnetic films made of amorphous materials had a problem of the thickness of a soft magnetic substance increasing due to a low saturation magnetization.

Thus, the noises resulting from a soft magnetic film having a thickness ten times or more greater than the ferromagnetic layer on the double-layer film media have been an important problem. And there have been hopes for shortening the depositon time of this soft magnetic film or the development of a high saturation magnetization material to be used on soft magnetic films from the viewpoint of making the whole medium into a film.

And lately a soft magnetic material of the microcrystalline separation type wherein microcrystalline grains are separated by heating an amorphous film after deposition has been proposed as a low-noise soft magnetic film. (Atsushi Kikukawa, Yukio Honda, Yosiyuki Hirayama and Masaaki Futamoto: IEEE Trans. Magn., Vol 36, No. 3, September (2000) 2402). However, this soft magnetic material of the microcrystalline separation with a composition of FeTaC had a problem of an inferior corrosion resistance. In addition, the FeTaC soft magnetic film is well known for the possibility of controlling its soft magnetic property by changing the concentration of C. However, it is necessary prepare targets for different C content when the C content is varied resulting in a difficulty of controlling the soft magnetic property.

The present invention was made in order to solve the above problem, and therefore it is an object of the present invention to provide a perpendicular magnetic recording medium comprising a soft magnetic liner layer of low noises, that can be converted into a thin film, having an excellent corrosion resistance and an outstanding controllability of soft magnetic property, wherein information can be recorded and reproduced at a high recording density and the method of producing the same.

Another object of the present invention is to provide a production apparatus capable of producing efficiently a perpendicular magnetic recording medium having said outstanding characteristics.

A further object of the present invention is to provide a magnetic recording apparatus provided with said perpendicular magnetic recording medium.

### DISCLOSURE OF THE INVENTION

In order to achieve the objects described above, the present invention adopted the following structure.

The perpendicular magnetic recording medium of the present invention is a perpendicular magnetic recording medium comprising a soft magnetic underlayer (SUL), and a perpendicular recording layer made of a ferromagnetic substance, formed above the SUL and constituting the main recording layer the easy magnetization axis of which is oriented mainly in the perpendicular direction to the film surface wherein said SUL is made of a soft magnetic material having a composition of FeTaN.

The perpendicular recording medium according to the present invention resolved the problems of insufficient saturation magnetization and corrosion resistance and deterioration in flatness in the conventional soft magnetization liner layer by using a soft magnetic material with a composition of FeTaN for a SUL consisting of a double-layer film medium comprising a SUL and a perpendicular recording layer and thus realized a perpendicular magnetic recording medium with an outstanding noise property.

It is preferable that said SUL of the perpendicular magnetic recording medium related with the present invention contains microcrystalline grain of Fe separated in amorphous substance by heating. By this structure, it is possible to realize a SUL having both an outstanding soft magnetic property and a high saturation magnetization as a crystal texture wherein Fe microcrystalline grains having a grain size of nm order in amorphous substance are uniformly dispersed and separated by deposing a layer consisting of amorphous FeTaN as a SUL and then by heating this FeTaN layer.

The perpendicular magnetic recording medium related to the present invention is characterized in that said SUL has a flatness of 1.0 nm or less in surface roughness when the film thickness is within a range of 100 nm-500 nm. Due to said flatness of the SUL, the perpendicular magnetic recording medium related to the present invention can suppress magnetic flux leakage from magnetic poles resulting from the roughness of the film surface and realize a low-noise medium.

And it is preferable that said surface roughness be 0.5 nm or less, and by realizing such a surface roughness it is possible to reduce its medium noise.

Then, the method of producing the perpendicular magnetic recording medium related to the present invention comprises a step of depositing a SUL on the substratum, a step of heating said substratum and controlling the Fe nanocrystalline precipitated texture after the deposition of said SUL, a step of inducing an easy magnetization axis of the given direction in said SUL by disposing said substratum in magnetic field, and a step of depositing a perpendicular recording layer containing a ferromagnetic substance or substances above said SUL.

The method of producing the perpendicular magnetic recording medium related to the present invention is characterized in that, after the deposition of a SUL on the substratum, the substratum to which this SUL is deposited is heated to form a Fe nanocrystalline precipitated texture in the SUL, and the heated substratum is disposed in magnetic field to induce an easy magnetization axis of a given direction in the SUL. In other words, by separating the step of depositing the SUL and the step of controlling the Fe nanocrystalline precipitated texture in the SUL and of impressing magnetic field on the SUL, it has become possible control separately the condition of depositing the SUL, the condition of forming the Fe nanocrystalline precipitated texture and the condition of impressing magnetic field for inducing the easy magnetization axis in a given direction in the soft magnetization liner layer. Therefore, in the depositing step it has become possible to deposit a SUL of a higher quality, in the step of forming the Fe nanocrystalline precipitated texture it has become possible to control easily the soft magnetic property of the SUL, and in the step of impressing magnetic field it has become possible to control more precisely the easy magnetization axis in the SUL.

And according to the production method related to the present invention, it is possible to swap whenever deemed necessary the order between the step of inducing the easy magnetization axis in a given direction in said SUL and the step of depositing the perpendicular recording layer. In other words, it is possible to form a Fe nanocrystalline precipitated texture in the SUL, deposit a perpendicular recording layer and then induce an easy magnetization axis in a given direction in said SUL, and it is also possible to induce first the easy magnetization axis and then deposit the perpendicular recording layer.

According to the method of producing the perpendicular magnetic recording medium related to the present invention, it is preferable to carry out each of said steps consecutively in the vacuum. In other words, this process represents a production method wherein the substratum is processed in the vacuum while it is transferred from one step to another without being exposed to the outside air. The adoption of such a process makes it possible to control the Fe nanocrystalline precipitated texture of the SUL and to induce an easy magnetization axis of the SUL without exposing the deposited surface of the SUL to the outside air. And thus, it is possible to prevent the surface of the SUL from being oxidized due to its exposure to the outside air and its magnetic property from declining thereby, and thus to obtain a SUL with a superior soft magnetic property.

According to the method of producing the perpendicular magnetic recording medium related to the present invention, it is also possible to adopt a process of carrying out simultaneously the step of heating said SUL and controlling the Fe nanocrystalline. precipitated texture and the step of inducing an easy magnetization axis of a given direction in said SUL. In other words, this process consists of carrying out simultaneously the step of heat said substratum and the step of impressing magnetic field on the SUL. By adopting such a process, it is possible to fix more firmly the magnetization of the SUL. And as the whole process can be shortened, the production cost of the perpendicular magnetic recording medium can be reduced.

Incidentally, said process can prove effective as long as said steps are carried out successively in the vacuum. And for example the step of depositing an under layer under the SUL or the perpendicular recording layer may be included. In other words, in the case where a perpendicular recording medium comprising an under layer between the SUL and the substratum, various steps including the step of depositing this base layer may be carried out successively in the vacuum.

Then, the production apparatus of the perpendicular magnetic recording medium of the present invention comprises a first depositing chamber for depositing a SUL on the substratum, an anisotropy control chamber disposed subsequently to said first depositing chamber for inducing an easy magnetization axis of a given direction in said SUL, a second depositing chamber for depositing a perpendicular recording layer, a heating means for heating said substratum provided between said first depositing chamber and said anisotropy control chamber or in said anisotropy control chamber, and a magnetic field impressing means provided in said anisotropy controlling chanber for inducing an easy magnetization axis of a given direction in said SUL.

According to the production apparatus related with the present invention, due to the presence of the first deposition chamber for depositing the SUL separately from the anisotropy control chamber for inducing the easy magnetization axis of the SUL in a given direction, it is possible to separately control their respective production conditions. And it is also possible to separately control the Fe nanocrystalline precipitated texture of the SUL by means of the heating means provided between the first depositing chamber and the anisotropy control chamber and in the anisotropy control chamber. In addition, as the magnetic field impressing means provided in the anisotropy control chamber can be used to induce, for example if the substratum is discoidal, an easy magnetization axis in a radial direction, or a circumferential direction, or an isotropic direction, it is possible to produce a perpendicular magnetic recording medium with a superior controllability of anisotropy and an outstanding noise property.

On the other hand, the magnetic recording apparatus of the present invention comprises a perpendicular magnetic recording medium described in any of the above descriptions, a driving part for driving said magnetic recording medium, and a magnetic head for recording and reproducing magnetic information wherein magnetic information is recorded and reproduced by means of said magnetic head on said moving magnetic recording medium. As such a configuration includes a perpendicular magnetic recording medium with an outstanding noise property as described above, it is possible to provide a magnetic recording apparatus capable of recording and reproducing information with a higher density.

### BRIEF DESCRIPTIONS OF DRAWINGS

FIG. 1 is a schematic sectional view of a perpendicular magnetic recording medium, representing a mode of carrying out the present invention.

FIG. 2(a)-(c) are schematic views showing a production apparatus related to the perpendicular magnetic recording medium related to the present invention.

FIG. 3 is a graph showing the results of measuring the magnetization curves for embodiment 1.

FIG. 4 is a graph showing the results of measuring the magnetization curves for embodiment 2.

FIG. 5 is a graph showing the results of measuring the magnetization curves for embodiment 3.

FIG. 6 is a graph showing the results of measuring the magnetization curves for embodiment 4.

FIG. 7 shows the results of measuring the magnetization curves of embodiments 5-7, FIG. 7A shows the magnetization curves of embodiment 5, FIG. 7B shows the magnetization curves of embodiment 6 and FIG. 7C shows the magnetization curves of embodiment 7.

FIG. 8 is a graph describing the concept of stabilization energy of a banded magnetic domain structure.

FIG. 9 is a graph showing the relationship between the stabilization energy Eₜₒₜₒₐₗ of the banded magnetic domain structure and the medium noise.

FIG. 10 is an inplane X-ray diffraction profile of the test pieces of embodiments 5-7

FIG. 11 is a graph showing the relationship between the inplane crystal grain size in the α-Fe(110) plane and the medium noise.

FIG. 12 shows the results of measuring the magnetization curves of the test pieces of embodiments 8-10, FIG. 12A shows the magnetization curves of embodiment 8, FIG. 12B shows the magnetization curves of embodiment 9 and FIG. 12C shows the magnetization curves of embodiment 10.

FIG. 13 represents schematic views showing the direction of inducing the easy magnetization axis in the SUL of the test pieces for embodiments 8-10.

FIG. 14 is a cross-sectional view of a magnetic recording apparatus related to the present invention.

FIG. 15 is a plane view of the magnetic recording apparatus shown in FIG. 14.

### DESCRIPTION OF CODES

10. Perpendicular magnetic recording medium

11. Substratum

12. SUL

13. Perpendicular recording layer

16. Protective layer

### BEST MODE FOR CARRYING OUT THE INVENTION

The mode for carrying out the present invention will be described below with reference to drawings.

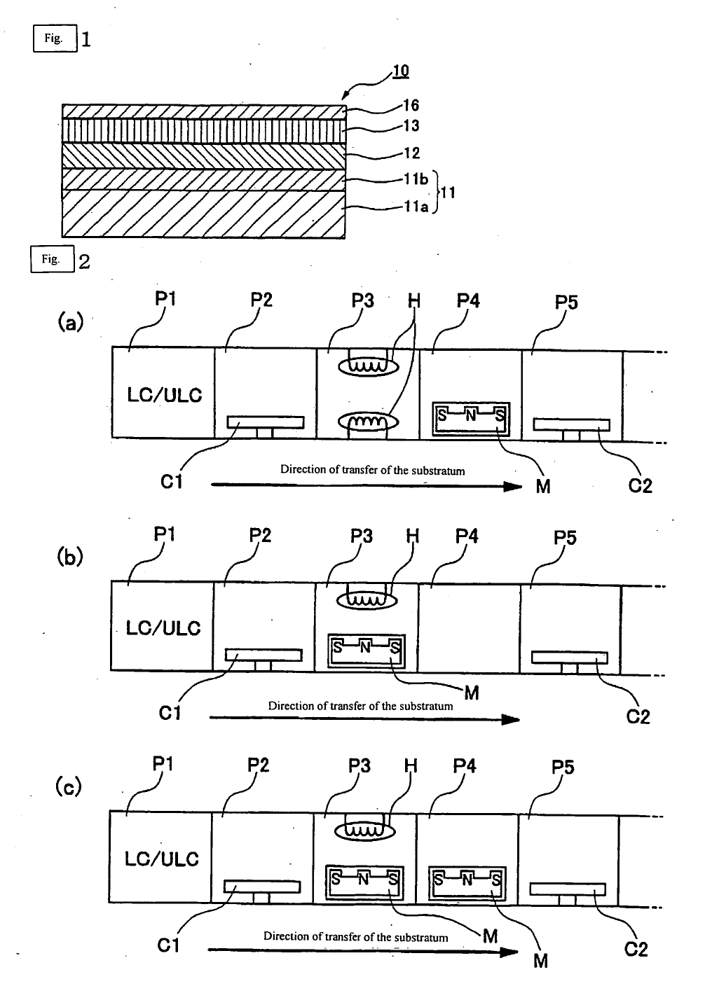

FIG. 1 is a sectional view showing schematically a mode of carrying out the perpendicular magnetic recording medium related to the present invention as applied on a computer hard disk. The perpendicular magnetic recording medium 10 shown in this view comprises a discoidal substratum 11 made of a non-magnetic substance at the bottom, a SUL 12 formed directly above, a perpendicular recording layer 13 made of a ferromagnetic substance and formed above this SUL and a protective layer 16 formed above this perpendicular recording layer 13.

<Perpendicular Magnetic Recording Medium>

The perpendicular magnetic recording medium related to the present invention is hereafter described with reference to drawings. The perpendicular magnetic recording medium shown in the following mode of carrying out, however, shows the basic structure and does not limit the present invention.

(Substratum)

As the substratum 11 related to the present invention, it is possible to mention a non-magnetic substratum 11a made of, for example, aluminum, titanium and alloys thereof, silicon, glass, carbon, ceramics, plastic, resin and combinations thereof, and the same coated with a non-magnetic coating film 11b made of a heterogeneous material whenever it is necessary by sputtering method, deposition method or electroplating method.

It is preferable that the non-magnetic coating film 11b with which the substratum 11a is coated would be non-magnetizable at high temperatures, conductive, a good thermal conductor, highly machineable and yet retains an adequate hard surface. As a non-magnetic coating film 11b meeting these conditions, especially a NiP film, a NiTa film, a NiAl film or a NiTi film made by the sputtering method or the electroplating method are preferable.

Particularly in the case of the perpendicular magnetic recording medium, it is preferable to reduce the gap between the magnetic head and the medium in order to enable the head to read well signals written in a medium. In other words, when a magnetic head records and reproduces data by remaining afloat above the medium, it is necessary to reduce the distance of separation between them. Or it would be still better if it is possible to record and reproduce by not allowing the magnetic head remain afloat but by keeping the same in contact with the surface of the medium. Therefore, as the substratum 11 for the perpendicular magnetic recording medium, a material having an outstanding surface flatness is preferable. In addition, it is preferable to adopt a substratum wherein parallelism of both sides, circumferential swell, and surface roughness are adequately controlled. From these viewpoints, as a preferable substratum 11, for example, a glass substrate, a silicon substrate, an aluminum substrate, or any one of these substrates coated with a NiP film, a NiTa film, a NiAl film or a NiTi film may be mentioned. Particularly, a glass substrate is preferable because it is hard enough to make the substrate thin.

And the substratum 11 may be provided with a buffer layer for creating unevenness on its surface part in order to improve friction or abrasion when the surface of the perpendicular magnetic recording medium 10 and that of the magnetic head come into contact or slide during recording and reproduction.

In addition, the substratum 11 may comprise a seed layer in the form of not a two-dimensional flat film but in the form of a film of locally scattered islands as a layer constituting the nucleus for promoting the growth of crystals in the initial stage of growth of crystal grains forming part of the perpendicular recording layer 13 and the like to be accumulated thereon. Such a seed layer is expected to promote the miniaturization of crystal grains constituting stratified films formed thereon and the reduction of grain size dispersion thereof.

Furthermore, as a countermeasure for the contact and sliding between the surfaces of the perpendicular magnetic recording medium 10 and the magnetic head when the substratum 11 rotates and/or stops (Contact Start Stop, CSS), roughly concentric slight textures may be created on the surface of the substratum 11 in the same way as the substratum for the conventional inplane magnetic recording medium. (SUL)

As the material for the SUL 12 related to the present invention, a soft magnetic material with a composition of FeTaN is used. By using the this FeTaN alloy, it is possible to prevent spike noise resulting from a 180° Bloch domain wall structure, prevent the liner layer from becoming a thick film due to an insufficient saturation magnetization and to produce a perpendicular magnetic recording medium with an outstanding noise property.

And as an important characteristic of this FeTaN alloy, an outstanding corrosion resistance may be mentioned. As the corrosion resistance of any medium is directly related with the reliability of any magnetic recording apparatus related thereto, it is very important. And by using a perpendicular magnetic recording medium provided with a SUL of said structure, it is possible to produce easily a magnetic recording apparatus having an excellent reliability.

And it is preferable that the SUL 12 related to the present invention has a Fe nanocrystalline precipitated texture. This microcrystalline separation texture is a crystal texture wherein the Fe microcrystalline of an nm order is uniformly dispersed and separated in an amorphous substance by heating a FeTaN layer deposited as an amorphous substance. And by adopting such a crystal texture, it is possible to induce a magnetic anisotropy of a desired direction and size and to form a SUL 12 of a high saturation magnetization and an outstanding property. And by adopting such a crystal texture, it is possible to maintain the flatness of the surface even if the film thickness is increased. Specifically, it is possible to realize a flatness of 1.0 nm or less of the surface roughness when the film thickness is within a range of 100-500 nm. Since a SUL 12 having such an outstanding flatness enables to reduce magnetic flux leakage from the magnetic pole resulting from the unevenness of the surface, it is possible to realize an outstanding noise property in this respect.

When the film thickness of this SUL is too thick, noise resulting from the SUL increases. And in addition an increase in deposition time results in a reduced production efficiency. Therefore, it is preferable to reduce the film thickness to the maximum extent possible. Thus, it is possible to realize a perpendicular magnetic recording medium having a superb noise property by reducing thus the film thickness. Since the FeTaN alloy used in the SUL 12 related to the present invention is a material having a high saturation magnetization of about 1.4-1.7 T, it is possible to reduce the thickness of the SUL 12 and make it thinner than the conventional amorphous soft magnetic materials such as CoZrNb. Incidentally, the thinner the thickness of the SUL 12 is, the easier it will be to obtain said effect. However, when it is too thin, the effect of converging the magnetic flux near the main magnetic pole of the head cannot be obtained and this will restrict any rise in the coercive force of the perpendicular recording layer 13 characterizing double-layer film media. Thus, practically it will be restricted to an appropriate thickness by Ms of the SUL 12 and the magnetomotive force property of the magnetic head combined therewith.

And one or more under layer or layers may be formed between the SUL 12 and the substratum 11. By forming such an under layer, it will be possible to use this under layer to control the magnetic domain structure of the SUL 12. As this under layer, it will be possible to use for example Cr, Ti, Ta and other materials although there is no particular restriction. And by using a base layer made of such materials, it will be possible to prevent the formation of any magnetic domain structure (banded magnetic domain structure) wherein magnetization in a perpendicular direction occurs at every more or less constant width in the SUL 12.

(Perpendicular Recording Layer)

For the perpendicular recording layer 13 related to the present invention, a magnetic film having a hexagonal closest packed structure (hcp) and composed mainly of Co and Cr wherein the easy magnetization axis is oriented in a nearly perpendicular direction to the film surface may be used, and other elements may be added thereto whenever it is necessary. As specific materials constituting the perpendicular recording layer 13, CoCr (Cr<25 at %), CoCrNi, CoCrTa, CoCrPt, CoCrPtTa, CoCrPtB and other alloyes may be mentioned: And for controlling the grain size and the segregation among grains of the crystal grains constituting the perpendicular recording layer 13, controlling the crystallomagnetic anisotropy constant Ku^{grain} of the crystal grains constituting the perpendicular recording layer 13, and controlling the corrosion resistance of the perpendicular recording layer 13, materials formed by adding Fe, Mo, V, Si, B, Ir, W, Hf, Nb, Ru or elements selected from rare earth elements other than the elements constituting said alloys may be used.

And in addition to said CoCr alloy, CoPt, CoPd, FePt and other thermal decay resistant materials and materials wherein B, N, O, Zr, and the like are added to pulverize them into microfine powder may be used. And a perpendicular recording layer formed by laminating multiple layers of Co layer and Pt layer may be applied. As such a laminated perpendicular recording layer, a laminated perpendicular recording layer formed by laminating a Co layer and a Pd layer, or a Fe layer and a Pd layer, or one formed by adding B, N, O, Zr and the like to each of these layers may be applid.

And in the perpendicular magnetic recording medium 10 of the present mode of carrying out, an under layer may be provided between the SUL 12 and the perpendicular recording layer 13. As the material for this under layer, any material that can transform the perpendicular recording layer 13 formed thereon into a perpendicular magnetization film may be used. And the under layer may be formed to a single layer structure, a two-layer structure or a multi-layer structure.

This under layer may be formed including layers made of a metal material consisting of Ti, Ta, Ru, Cu, Pt, Rh, Ag, Au and other single elements or alloy materials constituted by adding Cr and the like to these elements, provided that the perpendicular recording layer 13 is made of a CoCr material. If the perpendicular recording layer 13 is made of CoPt, CoPd, FePt and other thermal decay resistant materials or a multi-layered film of these materials, it may be constituted by including a layer or layers of C, Si, SiN, SiO and the like. If these materials are used for the under layer, coercive force or squareness ratio can be improved. Or one or more types of elements chosen from N, Zr, C, B and the like may be added to these materials to the extent that their crystallinity may not be damaged. The addition of these elements accelerates the minification of crystal grains of the under layer 15, and the effect of improving the recording and reproduction property of the medium can be expected thereby.

<Method of Producing Perpendicular Magnetic Recording Medium and Apparatus for Producing the Same>

And now, the method of producing the perpendicular magnetic recording medium related to the present invention and the apparatus of producing the same will be explained hereafter.

(Sputtering Method)

As a method for producing the perpendicular magnetic recording medium 10 related to the present invention, a sputtering method may be used. For this sputtering method, a carrying-type sputtering method wherein a thin film is formed while the substratum moves before the target, and a static-type sputtering method wherein a thin film is formed while the substratum is fixed before the target may be disclosed as examples.

The former carrying-type sputtering method is high productive and therefore is advantageous for the production of low-cost magnetic recording media, and the latter static-type sputtering method, due to a stable incident angle of the sputtering particles to the substratum, enables to produce magnetic recording media having an excellent recording and reproduction property. The production of perpendicular magnetic recording media 10 related to the present invention, however, is not limited to the carrying-type or the static-type.

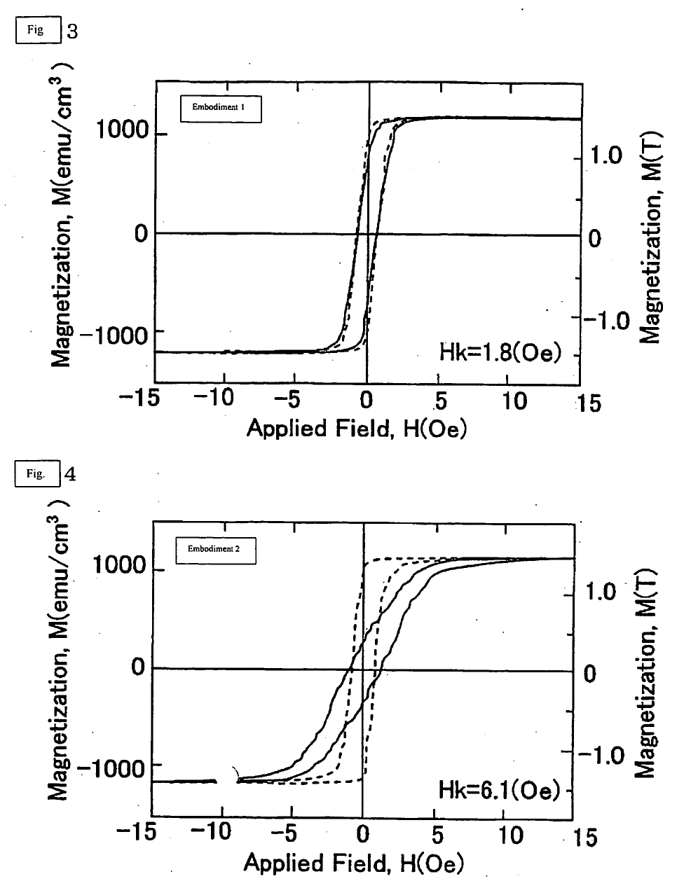

The production of the perpendicular magnetic recording medium 10 shown in FIG. 1 by means of the production apparatus and production method related to the present invention will be described below in details with reference to FIG. 2. FIG. 2 is a configuration illustration showing examples of the production apparatus of the perpendicular magnetic recording media related to the present invention. FIG. 2(a) shows the configuration for carrying out separately the step of heating the substrate 11 and the step of impressing magnetic field on the SUL 12, FIG. 2(b) shows the configuration for impressing magnetic field and heating the substratum 11 at the same time, and FIG. 2(c) shows the configuration for carrying out at the same time the step of heating the substratum 11 and the step of impressing magnetic field on the SUL 12 and in addition for impressing magnetic field even while cooling down the substratum 11. The production apparatuses shown in these FIGS. 2(a)-(c) are designed to deposit by the static sputtering method.

The production apparatus shown in FIG. 2(a) comprises five chambers P1-P5 arranged in the moving direction of the substratum. Chamber P1 is a load-unload chamber for loading and unloading the substratum, Chamber P2 is the first depositing chamber provided with a cathode C1 for sputtering, Chamber P3 is a structure control chamber provided with two heaters (heating means) H, Chamber P4 is an anisotropy control chamber provided with a magnet (magnet field impressing means) M, and Chamber P5 is the second depositing chamber provided with a sputtering cathode C2. And each chamber is provided with a carrier (not illustrated) for carrying the substratum that has been introduced therein so that the substratum 11 may be carried from the left to the right in the figure. And each chamber is provided with a evacuator (not illustrated) for evacuating the air inside.

Incidentally, after the second depositing chamber P5, other additional depositing chambers and heating chambers having a heater therein may be provided. For example, for the production of perpendicular magnetic recording media 10 shown in FIG. 1, the third depositing chamber for depositing a protective film 16 is provided after the second depositing chamber P5. And between each of the chambers an shutoff valve for isolating the neighboring chambers may be provided.

And FIG. 2 showed the case wherein the first and second depositing chambers P2 and P5 are provided with cathodes C1 and C2 only on one side. However, it is possible to provide them with two cathodes C1 and C2 arranged in such a way that they face each other. And the adoption of such a structure enables to deposit on both sides of the substratum 11.

On the other hand, the production apparatus shown in FIG. 2(b) is configured in the similar way as that of the production apparatus shown in FIG. 2(a) above, and the special feature of the production apparatus shown in FIG. 2(b) is that Chamber P3 is an anisotropy control chamber provided with a magnet M and a heater H arranged opposite to this magnet M, and that Chamber P4 is a cooling chamber for cooling the substratum after magnetic field is impressed.

And the production apparatus shown in FIG. 2(c) is provided with a magnet M in Chamber P4 in addition to the configuration shown in FIG. 2(b) so that it may be possible to impress magnetic field on the substratum 11 even while the substratum 11 is cooled down. In this case, Chamber P4 will be configured in such a way that it plays concurrently the role of an anisotropy control chamber and a cooling chamber shown in FIGS. 2(a) and (b).

When the production apparatus shown in FIG. 2(a)-(b) are used to produce perpendicular magnetic recording media, the cathode C1 of the first depositing chamber P2 is fitted with a FeTa alloy target for depositing a SUL, and the cathode C2 of the second depositing chamber P5 is fitted with a ferromagnetic material (for example Co alloy) target for depositing a perpendicular recording layer. And the first depositing chamber P2 is connected with a supply source of Ar gas (not illustrated) and a supply source of N₂ gas (not illustrated) for sputtering with a mixed gas of Ar and N₂ and the second depositing chamber is connected with at least a supply source of Ar gas (not illustrated).

When the production apparatus shown in FIG. 2(a) are used to produce the perpendicular magnetic recording media 10 shown in FIG. 1, the substratum 11 is at first introduced into the load-unload chamber P1. And then the substratum 11 is transferred to the first depositing chamber P2, where the FeTa target is used to proceed to a sputtering by using a mixed gas of Ar and N₂ as the process gas and to deposit a SUL 12 on the substratum 11.

Then, when the deposition of the SUL 12 is completed, the substratum 11 is transferred to the following structure control chamber P3, and the heater H is put into operation to heat the substratum 11 (the SUL 12) until its surface reaches a temperature of approximately 400° C. or more and to form a Fe nanocrystalline precipitated texture in the SUL 12. By applying the production method related to the present invention, it is possible to control the soft magnetic characteristics of the SUL 12 by the heating condition in this structure control chamber P3.

Then, when the heating of the substratum 11 is completed, the substratum 11 is transferred to the anisotropy control chamber P4, where the substratum 11 is disposed on the front surface of the magnet M to make the magnet M impress magnetic field on the SUL 12. In this step, an easy magnetization axis in the direction of the radius of the substratum 11 is induced in the SUL 12. And at the same time, the substratum 11 that had been heated in the anisotropy control chamber P4 is cooled.

Then, when the induction of the easy magnetization axis by the impression of magnetic field is completed, the substratum 11 is transferred to the second deposition chamber P5 where a perpendicular recording layer 13 is deposited. And when the deposition of the perpendicular recording layer 13 is completed, the substratum 11 is transferred to a deposition chamber (not illustrated) provided after the second deposition chamber P5, where a protection layer 16 is deposited. The substratum 11 on which the steps described above have been completed is transferred again to the load-unload chamber P1, from where it is taken out. In this way, the perpendicular magnetic recording media 10 related to the present invention can be produced by using the production apparatus shown in FIG. 2(a).

According to the production method of the present invention described above, after a SUL 12 is deposited on the substratum 11, the substratum 11 is heated to form a Fe nanocrystalline precipitated texture on the SUL 12, and the substratum 11 that had been heated is disposed in magnetic field to induce an easy magnetization axis of a given direction in the SUL 12. Therefore, it is possible to control separately the depositing condition of the SUL, the forming condition (heating condition) of the Fe nanocrystalline precipitated texture and the condition of impressing magnetic field. As a result, in the depositing step at the first deposition chamber P2, it is possible to deposit a SUL 12 of a higher quality, in the forming step of a Fe nanocrystalline precipitated texture at the structure control chamber P3, it is possible to control more finely the soft magnetic characteristics of the SUL 12, and in the step of impressing magnetic field at the anisotropy control chamber P4, it is possible to control magnetization with a higher precision.

And the inclusion of a step of heating the substratum 11 between the step of depositing a SUL 12 and the step of impressing magnetic field serves to establish a system of controlling separately the heating condition and to enhance the controllability of the substratum temperature.

On the other hand, the production apparatus shown in FIG. 2(b) can be used to produce perpendicular magnetic recording media 10 of the structure shown in FIG. 1. This method is different from the production method of using the production apparatus shown in said FIG. 2(a) in that the substratum 11 is heated at the same time as magnetic field is impressed on the SUL 12 in the anisotropy control chamber P3 and after the step of impressing magnetic field is completed, the substratum 11 is cooled in the cooling chamber P4. The adoption of such a production method can shorten the production process and therefore reduce the production cost of the perpendicular magnetic recording media.

And the production apparatus shown in FIG. 2(c) can also be used to produce the perpendicular magnetic recording media 10 of the structure shown in FIG. 1. In this case, it is possible to obtain an effect that the magnetization of the SUL 12 can be more firmly fixed in addition to the effect obtained by using the production apparatus shown in FIG. 2(b). This is due to the fact that, in the production apparatus shown in FIG. 2(c), Chamber P3 and Chamber P4 are provided with a magnet M for impressing magnetic field so that it may be possible to impress magnetic field on the substratum 11 irrespective of whether the substratum 11 is being heated or cooled down.

The SUL 12 formed by the production method related to said present invention comprises a Fe nanocrystalline precipitated texture, and according to the production method related with the present invention it is possible to control easily this Fe nanocrystalline precipitated texture by means of the depositing condition of the SUL 12 (flow of N₂) in the first depositing chamber P2 and the heating condition (heating temperature) in the structure control chamber P3. As a result, it is possible to control easily the soft magnetic characteristics of the SUL 12 and therefore to produce a SUL 12 having an excellent noise property with a good reproducibility.

And according to the production method of the present invention, it is enough to prepare low-cost FeTa targets, Ar and N2 which are general purpose gases, heater H and other heating means to form said SUL 12 having an excellent noise property and to produce easily and at low costs low-noise perpendicular magnetic recording media.

The production method described above adopted a process of impressing magnetic field in the radial direction of the substratum 11 in the anisotropy control chamber P3 in order to induce an easy magnetization axis in the radial direction of the substratum 11 in the SUL 12. However, in the perpendicular magnetic recording medium 10 related to the present invention and the method of producing the same, the orientation of this easy magnetization axis is not limited to the radial direction of the substratum 11 but the same can be induced in the circumferential direction of the substratum 11 or can be induced isotropically. However, when the magnetic recording medium of the present invention is used in a magnetic recording apparatus that records and/or reproduces by rotating a discoidal medium, from the viewpoint of its recording principle and the reduction of noises, it is preferable to magnetize the SUL 12 in the radial direction of the substratum 11.

In the meanwhile, when the SUL 12 is to be magnetized in the circumferential direction of the substratum 11, it is enough to make a magnet M provided in the production apparatus shown in FIG. 2(a)-(c) rotatable, and when any other magnetization directions are chosen, it is possible to address easily to the situation resulting therefrom by changing the form or polarity of the magnet M.

As impurities for the Ar gas used for deposition in the production method related to the present invention, for example, H₂O, O₂, CO₂, H₂, N₂, CₓH_{y}, H, C, O, CO and the like are mentioned. The impurities having a strong influence on taking O₂ into a deposition film may be H₂O, O₂, CO₂, O, CO . Therefore, the concentration of impurity of the present invention shall be expressed by the total of H₂O, O₂, CO₂, O and CO contained in the Ar gas used for depositing.

For producing magnetic recording media related with the present invention, it is possible to use a deposition chamber with a high vacuum used by the current mass-production apparatus for which the ultimate vacuum in the depositing chamber for depositing a perpendicular recording layer 13 made of a ferromagnetic substance shown in FIG. 1 is set at 10⁻⁷ Torr level (10⁻⁵ Pa level). It is needless to mention that a ultraclean process wherein the ultimate vacuum in the depositing chamber is set at 10⁻⁹ Torr level (10⁻⁷ Pa level ) and the concentration of impurity of the gas for depositing is set at 1 ppb or less may be used. Since the adoption of the ultraclean process reduces the initial layer of the perpendicular recording layer 13 and allows us to obtain a perspective of better squareness ratio and coercive force of the medium, it is possible to produce easily magnetic recording media having respectively an excellent recording and reproducing characteristics.

### EMBODIMENTS

The present invention will be described hereafter in greater details by citing some embodiments. However, the present invention shall not be limited to the following embodiments.

### EMBODIMENTS 1-4

In these embodiments, perpendicular magnetic recording media having the following structure were produced.

A SUL and a protection layer were successively formed upon the substratum consisting of a discoidal glass substrate by means of production apparatus shown in FIG. 2(a) to prepare test samples, which were named test samples for the embodiments 1-4. The manufacturing conditions are shown in Table 1.

TABLE 1

| | |
|---|---|
| Depositing method | DC magnetron sputtering |
| | method |
| Material of the substratum | Crystallized glass |
| Surface roughness of the substratum | Ra < 0.3 nm |
| Ultimate vacuum of the depositing | <1 × 10⁻⁷ Torr |
| chamber | |
| Process gas | Ar, N2 |
| Impurity concentration of Ar gas | <1 ppm |
| Whole gas flow rate | 160 sccm |
| Whole gas pressure | 0.4 Pa |
| N₂ flow rate ratio (FN₂/Fₜₒₜₐₗ) | 5-20% |
| Surface temperature of the substratum | Room temperature |
| during depositing | |
| SUL | FeTaN |
| Thickness of the SUL | 300 nm |
| Heating of the SUL | One-side lamp heater (heater |
| | temperature: 550° C.) |
| Heating time of the SUL | 3,600 sec |
| Condition for impressing magnetic field | In the radial direction of the |
| | substratum: 20-50 (Oe) |
| Condition for cooling | 1,200 sec |
| Protection layer | Carbon (7 nm) |

The samples described above were deposited and made by means of a production apparatus having a back pressure condition of 10⁻⁷ Torr level (10⁻⁵ Pa level) used in the current mass-production machines. During the manufacturing process, the temperature of the substratum chosen during the deposition of the SUL was the room temperature, a mixed gas of Ar and N₂ was used as a process gas, and the whole gas pressure during deposition was set at 0.4 Pa. N₂ flow rate ratio during the deposition of the SUL in the first depositing chamber P2 was changed and all the other conditions were maintained at the same level when the four types of samples were produced. The N₂ flow rate ratio of each of the samples for embodiments 1-4 is shown in Table 2.

And a discoidal glass substratum was used for the substratum, and the discoidal media made were processed by means of a ultrasonic processing machine M100 (made by Choonpa Kogyo K. K.) into circular samples with a diameter of 8 mm.

TABLE 2

| | N₂ flow rate ratio | Surface |
|---|---|---|
| | (FN₂/Fₜₒₜₐₗ) | roughness (Rₐ) |
| Embodiment 1 | 5% | 0.19 nm |
| Embodiment 2 | 10% | 0.22 nm |
| Embodiment 3 | 15% | 0.27 nm |
| Embodiment 4 | 20% | 0.28 nm |

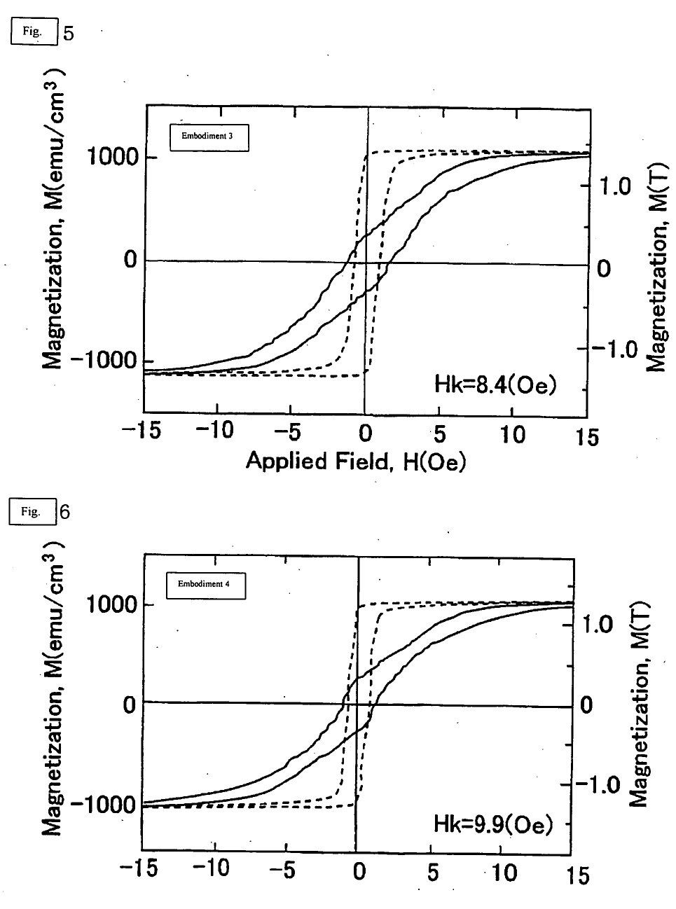

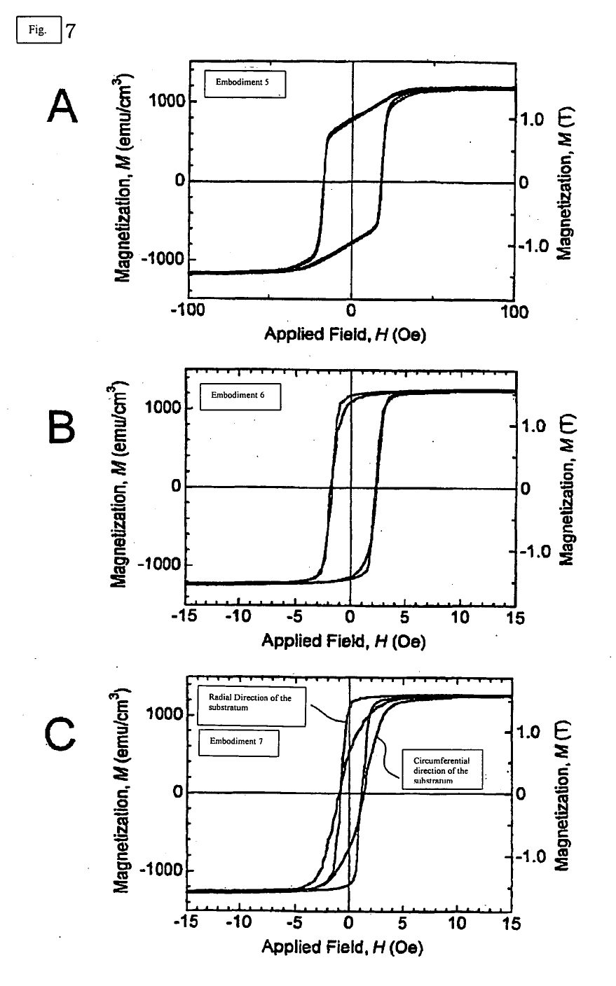

The saturation magnetization Ms of the samples for embodiments 1-4 obtained as shown above was measured by means of a vibration sample type magnetometer (VSM: made by Riken Denshi K. K. BHV-35). The measurements are shown in FIGS. 3-6. The magnetization curves shown by solid lines among those shown in these figures represent the magnetization curves in the circumferential direction of the substratum 11, and the curves shown by broken lines represent the magnetization curves in the radial direction of the substratum 11. And at the right bottom of each graph, Hk of samples are shown.

As shown in the graphs contained in FIGS. 3-6, it will be understood that Hk of the SUL 12 tend to increase as N₂ flow rate ratio increase. Therefore, it has been confirmed that the magnetic recording media having the structure related to the present invention can control very easily Hk of the SUL 12 by changing N₂ flow rate in their production process. It has been found lately that any difference in the value of Hk of the SUL 12 of double-layer film media can have a great impact on the improvement of the floating magnetic field resistance of perpendicular magnetic recording media, and the controllability of Hk of the SUL is now becoming an important factor. Therefore, the perpendicular magnetic recording media related to the present invention capable of controlling Hk by the nitrogen flow rate ratio during the deposition of the SUL enables to make the design of media easier and is preferable for magnetic recording apparatuses designed to record and reproduce at a high density. In addition, as shown in Table 2, with regards to their surface roughness, all the samples of embodiments 1-4 had a good surface roughness of 0.3 nm or less. This surface roughness is more or less similar to that of the substratum before the deposition of the SUL 12, and from this viewpoint the SUL related with the present invention is not considered as causing any deterioration in the surface roughness of the substratum.

### EMBODIMENT 5-7

Then, samples of the similar structure as those of embodiments 1-4 were made with the conditions shown in Table 3 and 4 by means of the production apparatus of the perpendicular magnetic recording media related with the present invention, and they were taken as the samples for embodiments 5-7.

TABLE 3

| | |
|---|---|
| Depositing method | DC magnetron sputtering |
| | method |
| Material of the substratum | Crystallized glass |
| Surface roughness of the substratum | Ra < 0.3 nm |
| Ultimate vacuum of the depositing | <1 × 10⁻⁷ Torr |
| chamber | |
| Process gas | Ar, N₂ |
| Impurity concentration of Ar gas | <1 ppm |
| Whole gas flow rate | 60 sccm |
| Whole gas pressure | 0.7 Pa |
| N₂ flow rate ratio (FN₂/Fₜₒₜₐₗ) | 0-50% |
| Surface temperature of the substratum | Room temperature |
| during depositing | |
| SUL | FeTaN |
| Thickness of the SUL | 300 nm |
| Heating of the SUL | One-side lamp heater (1,000 W) |
| Heating time of the SUL | 90 sec |
| Condition for impressing magnetic field | In the radial direction of the |
| | substratum: 600-1,000 (Oe) |
| Condition for cooling | 800 sec |
| Protection layer | Carbon (7 nm) |

TABLE 4

| | N₂ flow rate ratio (FN₂/Fₜₒₜₐₗ) |
|---|---|
| Embodiment 5 | 3 sccm/60 sccm(5%) |
| Embodiment 6 | 6 sccm/60 sccm(10%) |
| Embodiment 7 | 9 sccm/60 sccm(15%) |

With regards to samples for embodiments 5-7 obtained as described above, the crystal structure of thin films made on the substratum was analyzed by means of an inplane X ray diffraction method (XRD: developed by Riken Denki K. K. ATX-G). And the saturation magnetization Ms of the samples was measured by means of a vibration sample type magnetometer (VSM: made by Riken Denshi K. K. BHV-35).

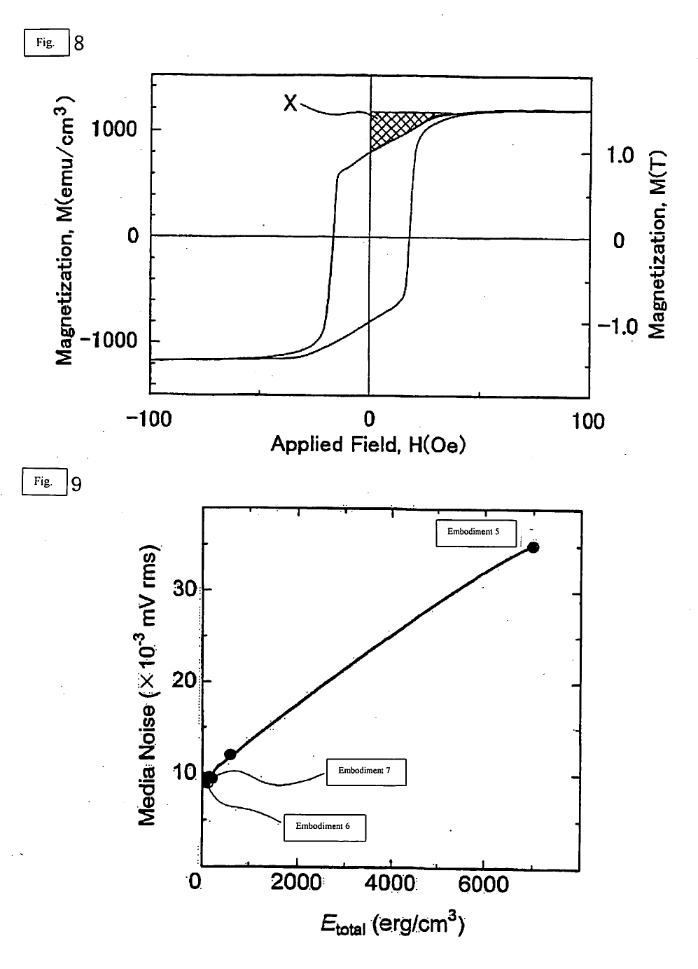

Magnetization curves obtained by the VSM measurement of the samples of said embodiments 5-7 are shown respectively in FIGS. 7A-C. These figures show that, as the flow rate ratio of N₂ grew larger, the coercive force of the SUL diminished and that the soft magnetization of the SUL progresses as the flow rate of N₂ increases. And the magnetization curves of the samples of embodiment 5 shown in FIG. 7A show moderate changes of magnetization in the range of ±approximately30 Oe and indicate a different situation from the magnetization curves shown in FIGS. 7B and C. The measurement of the samples of this embodiment 5 by means of a MFM (magnetic force microscope) confirmed that a banded magnetic domain had been formed on the SUL. In other words, the change of magnetization curves shown in FIG. 7A is considered to have been caused by such a banded magnetic domain structure.

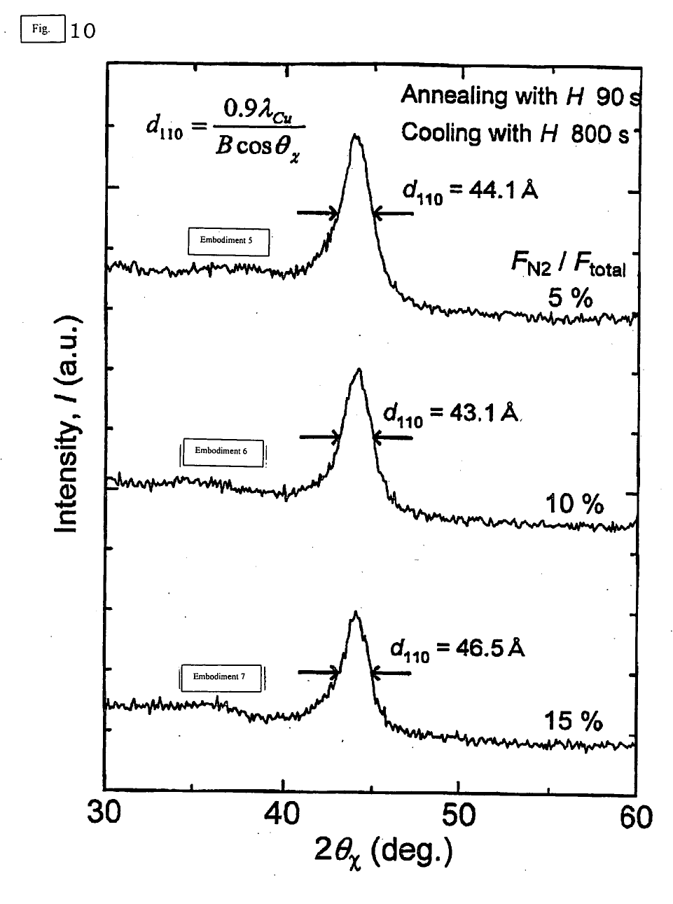

The stabilization energy Eₜₒₜₐₗ of this banded magnetic domain structure is defined as the difference between a banded magnetic domain state (residual magnetization state) and a single magnetic domain state (saturation magnetization state), and in the case of a SUL having magnetization curves as shown in FIG. 8, this stabilization energy Eₜₒₜₐₗ can be calculated from the area of the domain X shown in FIG. 8. And this stabilization energy Eₜₒₜₐₗ can be expressed by a formula shown in the following (Number 1). In this way, the stabilization energy of the banded magnetic domain structure was to be evaluated quantitatively.

$${E}_{total} = ( 2 π {M}_{s}^{2} λ - \frac{{K}_{u} h}{2} + \frac{2 {π}^{2} Ah}{{λ}^{2}} ) {θ}_{0}^{2} \qquad Number 1$$

Provided however that various variables are defined as follows in (Number 1). The first member in the brackets on the right side (Number 1) represents static magnetic energy, the second member represents perpendicular magnetic anisotropic energy and the third member represents exchange energy.

λ: Wavelength of a band of the banded magnetic domain structure

Ku: Perpendicular magnetic anisotropy energy

h: Film thickness of the SUL

A: Exchange constant

θ₀: Build up angle

The result of measuring the stabilization energy of the banded magnetic domain structure by said method and the result of measuring the medium noise of the samples of said embodiments 5-7 are shown in FIG. 9. The horizontal axis of the graph shown in FIG. 9 represents the stabilization energy Eₜₒₜₐₗ of the banded magnetic domain structure, and the vertical axis represents the medium noise. As shown in this figure, the stabilization energy Eₜₒₜₐₗ of the banded magnetic domain structure and the medium noise are more or less proportionate, and from this fact it was found that the medium noise of a SUL of which the banded magnetic domain structure is stable grows very large. This suggest that it is possible to control medium noise by means of a stabilization energy Eₜₒₜₐₗ that can be qualitatively evaluated by a VSM measurement as described above.

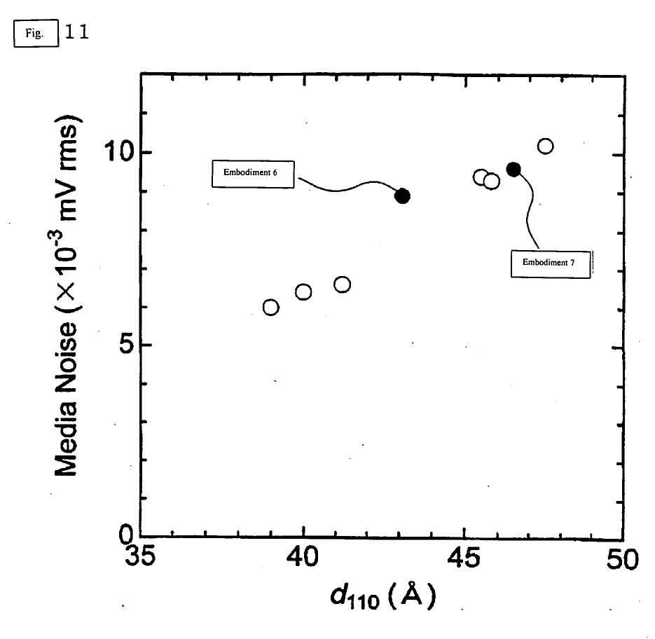

And now, the inplane X ray diffraction profile of the samples of said embodiments 5-7 based on XRD measurements will be shown in FIG. 10. From a half of the value fluctuation range of the α-Fe(110) plane diffraction curve in the diffraction profile shown in this figure, the inplane crystal grain size of the Fe microcrystalline constituting the SUL was calculated by using Scheller's formula shown at the upper left side of FIG. 10. Incidentally, the dissociation of the crystal grain size calculated by using this Scheller's formula from that obtained from the TEM image has been discussed. However, the relative relations of crystal grain sizes conform with TEM, and since importance is given to the relative relations of crystal grain sizes in the present invention, this measurement method that can be easily applied was adopted.

As shown in FIG. 10, the crystal grain size of the samples of embodiment 6 having a N₂ flow rate ratio of 10% is smaller than that of the samples of embodiment 7 having a N₂ flow rate ratio of 15%, and the result of noise measurement shown in FIG. 9 suggests that the smaller the crystal grain size of the SUL is, the medium noise becomes smaller.

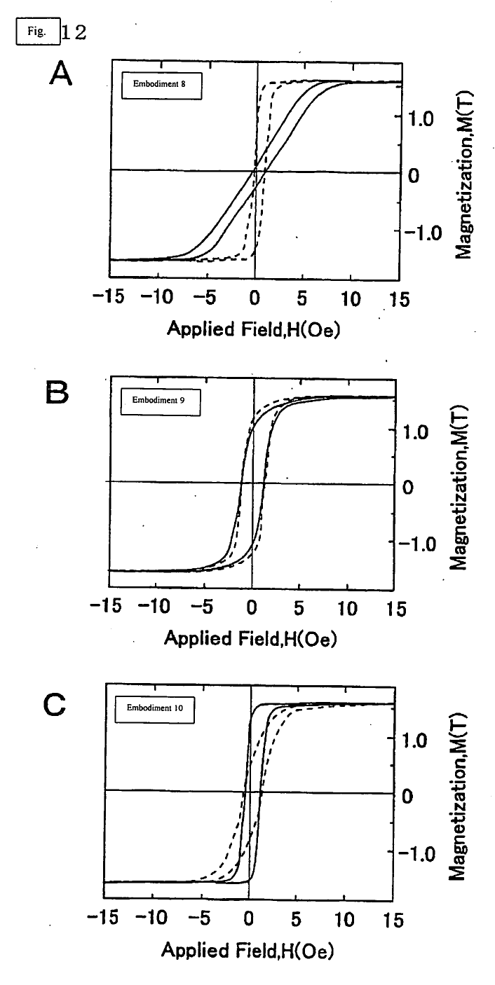

Then, samples were made by selecting similar conditions as said embodiments 6 and 7 except that the SUL is deposited by varying N₂ flow rate ratio to different values in order to clarify the relations between the crystal grain sizes when no banded magnetic domain structure is formed and the medium noises, and based on the result of measuring the X ray diffraction profile thereof, the crystal grains were calculated by using a method similar to the one mentioned above. And the medium noises for each sample were measured. The results thereof are shown in FIG. 11. The horizontal axis of the graph of FIG. 11 shows the inplane crystal grain size of the α-Fe(110) plane, and the vertical axis shows the medium noises. As this figure shows, the inplane crystal grain size and the medium noises have good mutual relations, and the smaller the inplane crystal grain size is, the lower the medium noises can be reduced.

The graph of FIG. 9 shows that the smaller the stabilization energy Eₜₒₜₐₗ of the banded magnetic domain structure is, the lower the medium noises can be reduced. When a banded magnetic domain structure has been formed, the medium noises can be easily assumed. However, when almost no banded magnetic domain structure has been formed as in the case of samples for embodiments 6 and 7, it is difficult to assume the medium noises by means of said stabilization energy Eₜₒₜₐₗ. When no banded magnetic domain structure has been formed as described above, as shown in FIG. 11, the method of assuming the medium noises based on the inplane crystal grain size may be used.

Therefore, in the case of magnetic recording media having a SUL related to the present invention, the medium noise can be easily assumed by measurements made using VSM and XRD, and the SUL can be easily optimized thereby. As a result, perpendicular magnetic recording media having better recording and reproducing characteristics can be realized.

Incidentally, the sample for embodiment 1 gave rise to no banded magnetic domain structure while the sample for embodiment 5 gave rise to one, in spite of the fact that the sample for embodiment 1 and that for embodiment 5 differed only in the forming condition (heating condition) of the Fe nanocrystalline precipitated texture and they were almost identical in other manufacturing conditions. This fact shows that, in the perpendicular magnetic recording media related to the present invention, it is possible to control the banded magnetic domain structure of the SUL by changing the heating condition even when the N₂ flow rate during deposition remains unchanged. More specifically, it is possible to restrict the formation of a banded magnetic domain structure by adopting heating conditions for low temperature and low speed (embodiment 1) instead of heating conditions for high temperature and high speed (embodiment 5).

### EMBODIMENT 8-10

Then, samples for the following embodiments 8-10 were fabricated in order to test the controllability in the easy magnetization axis direction of the SUL by the production apparatus related with the present invention. Tables 5 and 6 show the manufacturing conditions. Table 5 shows the common manufacturing conditions in embodiments 8-10, and Table 6 shows the varied manufacturing conditions for each sample of embodiments 8-10.

TABLE 5

| | |
|---|---|
| Depositing method | DC magnetron sputtering |
| | method |
| Material of the substratum | Crystallized glass |
| Surface roughness of the substratum | Ra < 0.3 nm |
| Ultimate vacuum of the depositing | <1 × 10⁻⁷ Torr |
| chamber | |
| Process gas | Ar, N₂ |
| Impurity concentration of Ar gas | <1 ppm |
| Whole gas flow rate | 60 sccm |
| Whole gas pressure | 0.7 Pa |
| N₂ flow rate ratio (FN₂/Fₜₒₜₐₗ) | 15% |
| Surface temperature of the substratum | Room temperature |
| during depositing | |
| SUL | FeTaN |
| Thickness of the SUL | 300 nm |
| Protection layer | Carbon (7 nm) |

TABLE 6

| | Embodiment 8 | Embodiment 9 | Embodiment 10 |
|---|---|---|---|
| Heating of the | Lamp heaters on | Lamp heater on | Lamp heater on |
| SUL | both sides | one side | one side |
| (Power | (750 W) | (1,000 W) | (1,000 W) |
| supplied to | | | |
| heater) | | | |
| Heating time of | 40 sec | 90 sec | 90 sec |
| the SUL | | | |
| Cooling | 800 sec | 800 sec | 800 sec |
| condition | | | |
| (Impression of | No impression of | No impression of | Magnetic field |
| magnetic field) | magnetic field | magnetic field | was impressed |

All the samples for said embodiments 8-10 can be produced by using any of the production apparatus shown in FIG. 2(a)-(c), and the use of any production apparatus may be chosen depending on the heating and cooling conditions.

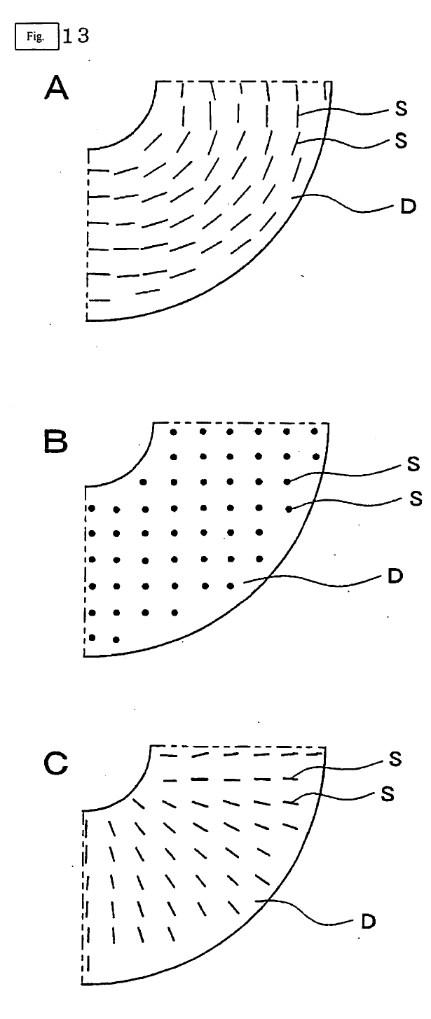

The samples for embodiments 8-10 made according to said manufacturing conditions were measured by VSM. The magnetization curves obtained by the measurement are shown in FIG. 12, and FIG. 13 shows schematically the direction of easy magnetization axis in the soft magnetic layer in each sample.

FIG. 12A-C correspond respectively to the samples of embodiment 8-10, and FIG. 13A-C correspond respectively to the samples of embodiments 8-10. And the solid line curves among the magnetization curves shown in FIG. 12 represent magnetization curves in the radial direction of the substratum, and the broken line curves represent magnetization curves in the circumferential direction of the substratum.

And the code D shown in FIG. 13A-C represents a part of a discoidal substratum, and the orientation and length of segments shown by the code S on the disk D show conceptually the orientation and size of the anisotropic magnetic field in the SUL. Dots show that the anisotropic magnetic field is almost zero or in other words isotropic.

With regards to the magnetization curves shown in FIG. 12A, the magnetization curves in the radial direction are considerably inclined in comparison with the magnetization curves in the circumferential direction of the substratum. This indicates that the magnetization in the circumferential direction of the substratum as shown in FIG. 13A is induced in the SUL of this sample for embodiment 8.

And regarding the magnetization curves shown in FIG. 12B, the magnetization curves in the circumferential direction of the substratum and the magnetization curves in the radial direction nearly overlap one on the other. This indicates that isotropic magnetization as shown in FIG. 13B is induced in the SUL of this sample for embodiment 9.

And regarding the magnetization curves shown in FIG. 12C, the magnetization curves in the circumferential direction are considerably inclined in comparison with the magnetization curves in the radial direction of the substratum. This indicates that the magnetization in the radial direction of the substratum as shown in FIG. 13A is induced in the SUL of this sample for embodiment 10.

Thus, it has been confirmed that according to the production apparatus and production method related to the present invention it is possible to induce magnetization in the circumferential direction of the substratum, in the radial direction of the substratum or isotropically by adequately controlling the production conditions thereof.

### EMBODIMENT 11

For this embodiment, samples for embodiment 11 and comparative examples 1 and 2 were produced by changing the materials constituting the SUL in order to test changes in medium noises due to the surface roughness of the SUL. Table 7 shows the manufacturing conditions of these samples, and Table 8 shows the target composition of the SUL, the product Ms·δ(T·nm) of the magnetization (Ms) and film thickness (δ), and film thickness δ(nm). And Table 9 shows the respective heating/cooling conditions and impression of magnetic field condition thereof.

TABLE 7

| | |
|---|---|
| Depositing method | DC magnetron sputtering |
| | method |
| Material of the substratum | Crystallized glass |
| Surface roughness of the substratum | Ra < 0.3 nm |
| Ultimate vacuum of the depositing | <1 × 10⁻⁷ Torr |
| chamber | |
| Process gas | Ar, N₂ |
| Impurity concentration of Ar gas | <1 ppm |
| Whole gas flow rate | 60 sccm |
| Whole gas pressure | 0.7 Pa |
| Process gas | Ar + N₂ (Embodiment 11) |
| | Ar (comparative examples 1, 2) |
| N₂ flow rate ratio (FN₂/Fₜₒₜₐₗ) | 15% (Embodiment 11) |
| Surface temperature of the substratum | Room temperature |
| during depositing | |
| Protection layer | Carbon (7 nm) |

TABLE 8

| | | SUL - | SUL - |
|---|---|---|---|
| | SUL - target | Ms · δ (T · nm) | thickness δ (nm) |
| Embodiment 11 | FeTaN | 450 | 300 |
| Comparative | FeAlSi | 450 | 375 |
| example 1 | | | |
| Comparative | NiFeMo | 450 | 600 |
| example 2 | | | |

TABLE 9

| | | | | Impression |
|---|---|---|---|---|
| | | | | of |
| | | | Cooling | magnetic |
| | Heater | Heating condition | time | field |
| Embodiment | Lamp heater | 1,000 W * 90 sec | 800 sec | Yes (during |
| 11 | on one side | | | cooling) |
| Comparative | Lamp heater | 750 W * 30 sec | 800 sec | None |
| example 1 | on both sides | | | |
| Comparative | Lamp heater | 750 W * 20 sec | 800 sec | None |
| example 2 | on both sides | | | |

The results of measuring the surface roughness and medium noises on the samples for embodiment 11 and comparative examples 1 and 2 manufactured according to said conditions are shown in Table 10. As shown in Table 10, the samples for embodiment 11 the surface roughness of which is considerably smaller than that of the samples for the comparative examples 1 and 2 showed sharply lower medium noises than those of the comparative examples 1 and 2. Therefore, it was confirmed that any perpendicular magnetic recording medium provided with a SUL related to the present invention would have an outstanding flatness of the medium and also an excellent noise property.

TABLE 10

| | Surface | Medium |
|---|---|---|
| | roughness | noise |
| | (nm) of | (×10⁻³ m |
| | the SUL | Vrms) |
| Embodiment 11 | 0.24 | 9.6 |
| Comparative example 1 | 1.9 | 73.8 |
| Comparative example 2 | 1.0 | 262 |

(Magnetic Recording Apparatus)

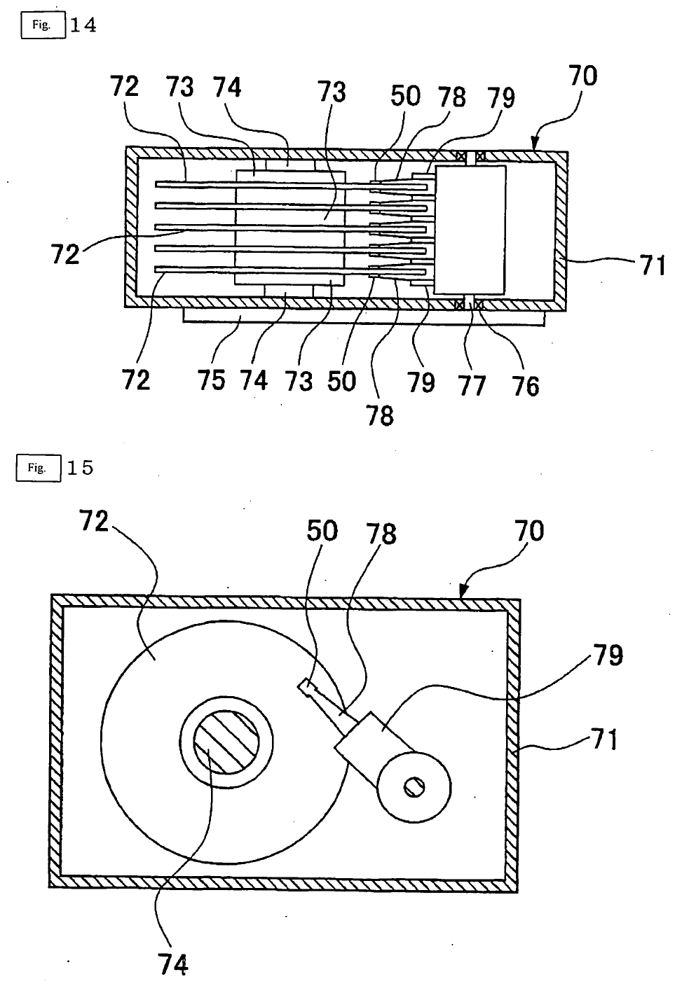

And now, the magnetic recording apparatus according to the present invention shall be described hereafter with reference to drawings. FIG. 14 is a cross-sectional view showing an example of hard disk device which is a magnetic recording apparatus related to the present invention, and FIG. 15 is a plane view of the magnetic recording apparatus shown in FIG. 14. In FIG. 14 and 15, 50 represents a magnetic head, 70 represents a hard disk device, 71 represents an enclosure, 72 represents a magnetic recording medium, 73 represents a spacer, 79 represents a swing arm and 78 represents a suspension.

The hard disk device 70 related to the present mode of carrying out takes in said magnetic recording medium of the present invention.

The hard disk device 70 is contained in an enclosure 71 made in the form of a rectangular paralleleped having an internal space enough to contain a discoidal magnetic recording medium 72, a magnetic head 50, etc. This enclosure 71 contains a plurality of magnetic recording media 72 sandwiched alternatively between spacers 73 and skewered around a spindle 74. The enclosure 71 is provided with a bearing (not illustrated) of the spindle 74. The enclosure 71 is also provided on the outside with a motor 75 for rotating the spindle 74. By this structure, all the magnetic recording media 72 are skewered rotatively around the spindle 74 and piled up a plurality of times being sandwiched by the spacers 73 and leaving enough space for allowing the magnetic head 50 to access thereon.

Inside the enclosure 71 and beside the magnetic recording medium 72, a rotary shaft 77 called “rotary actuator” is disposed being supported by the bearing 76 in parallel with the spindle 74. This rotary shaft 77 is provided with a plurality of swing arms 79 protruding in the space between each magnetic recording medium 72. At the top of each swing arm 79, a magnetic head 50 is provided through a suspension 78 in the form of a slender triangular plate fixed in a direction obliquely facing the surface of each magnetic recording medium 72 above and below the same. This magnetic head 50, though not illustrated, is provided with a record element for writing information on the magnetic recording medium 72 and a read element for reading information from the magnetic recording medium 72.

And the magnetic recording medium 72 is a perpendicular magnetic recording medium related to the present invention, that has an outstanding noise property and reliability due to the presence of a low-noise and durable SUL.

According to said structure, the magnetic head 50 can be moved to any position on the magnetic recording medium 72 because the magnetic head 50 can be moved in the radial direction of the magnetic recording medium 72 by moving the swing arm 79 after the magnetic recording medium 72 starts rotating.

In the hard disk device 70 of said structure, it is possible to write desired magnetic information on the magnetic recording medium 72 by rotating the magnetic recording medium 72, by moving the swing arm 79 and by having the magnetic field generated by the magnetic head 50 work on a ferromagnetic metal layer constituting the magnetic recording medium 72. It is also possible to read magnetic information by moving the swing arm 79, moving the magnetic head 50 to any position on the magnetic recording medium 72 and by detecting leakage magnetic field from the ferromagnetic metal layer constituting the magnetic recording medium 72 by means of a read element of the magnetic head.

With regards to reading and writing magnetic information in this way, if the magnetic recording medium 72 has an outstanding noise property as well as excellent recording and reproduction characteristics, it is possible to provide a hard disk device 70 capable of recording and reproducing magnetic information at a high density.

Incidentally, the hard disk device 70 described earlier with reference to FIGS. 14 and 15 shows an example of the magnetic recording apparatus related to the present invention, and the number of magnetic recording media to be loaded in the magnetic recording apparatus can be set at any number of one or more, and the number of magnetic heads to be mounted thereon can be set at any number of one or more. And the shape and the driving system of the swing arm 79 are not obviously limited to those shown in the drawings and the linear driving system or any other systems may be chosen.

Industrial Applicability

As described in detail above, the perpendicular recording medium of the present invention is a perpendicular magnetic recording medium comprising a SUL and a perpendicular recording layer formed above said SUL and constituting the main recording layer wherein the easy magnetization axis is oriented in the perpendicular direction to the film surface, and the problem of insufficient saturation magnetization and corrosion resistance in the conventional SUL, the formation of a 180° magnetic wall in the soft magnetic film and other problems are resolved due to the fact that said SUL is made of a soft magnetic material having a FeTaN composition, and thus a perpendicular magnetic recording medium having an excellent noise property has been realized.

Then, the method of producing a perpendicular magnetic recording medium of the present invention comprises a step of depositing a SUL over the substratum, a step of heating said substratum after the deposition of said SUL and of controlling a Fe nanocrystalline precipitated texture, a step of inducing an easy magnetization axis in a given direction in said SUL by disposing said substratum in magnetic field, and a step of depositing a perpendicular recording layer including a ferromagnetic substance over said SUL. And therefore it has become possible to separately control the depositing condition of the SUL, the forming condition of the Fe nanocrystalline precipitated texture, and the impressing condition of magnetic field. And thus it has become possible to deposit SULs of a higher quality in the depositing step, it has become possible to control the soft magnetic property of the SUL in the step of forming the Fe nanocrystalline precipitated texture, and it has become possible to control with a higher precision the easy magnetization axis of the SUL in the step of impressing magnetic field.

Then, the apparatus of producing the perpendicular recording media of the present invention comprises a first depositing chamber for depositing a SUL over a discoidal substratum, an anisotropy control chamber disposed after said first depositing chamber in order to induce an easy magnetization axis in a given direction in said SUL, a second depositing chamber for depositing a perpendicular recording layer, a heating means for heating said substratum between said first depositing chamber and said anisotropy control chamber or in said anisotropy control chamber. Due to the provision of a magnetic field impressing means for inducing an easy magnetization axis of a given direction in said SUL, it is possible to control separately the heating condition of the SUL and the condition of impressing magnetic field to the SUL. And due to the magnetic field impressing means provided in the anisotropy control chamber, it is possible to induce an easy magnetization axis of a given direction in the SUL, and therefore it is possible to produce perpendicular magnetic recording media with an excellent noise property.

Then, if the perpendicular magnetic recording medium of the present invention, a driving part for driving said magnetic recording medium and a magnetic head for recording and reproducing magnetic information are provided, and if magnetic information is recorded and reproduced by means of said magnetic head on and from said magnetic recording medium as the latter moves, it will be possible to provide a magnetic recording apparatus capable of recording and reproducing information at a higher density because of the provision of a magnetic recording medium having an excellent noise property.

1. A perpendicular magnetic recording medium comprising a soft magnetic underlayer (SUL), and a perpendicular recording layer made of a ferromagnetic substance, formed on the SUL and constituting the main recording layer the easy magnetization axis of which is oriented mainly in the perpendicular direction to the film surface, wherein
said SUL is made of a soft magnetic material having a composition of FeTaN.

2. A perpendicular magnetic recording medium according to claim 1 wherein said SUL includes Fe microcrystalline grains separated in an amorphous substance by heating.

3. A perpendicular magnetic recording medium according to claim 1, wherein
said SUL has a flatness of 1.0 nm or less in surface roughness for a film thickness range of 100 nm-500 nm.

4. A perpendicular magnetic recording medium according to claim 3, wherein
said SUL has a flatness of 0.5 nm or less in surface roughness for a film thickness range of 100 nm-500 nm.

5. A method of producing perpendicular magnetic recording media comprising
a step of depositing a SUL on the substratum,
a step of heating said substratum and controlling a Fe nanocrystalline precipitated texture after the deposition of said SUL,
a step of disposing said substratum in magnetic field and thereby inducing an easy magnetization axis of a given direction in said SUL, and
a step of depositing a perpendicular recording layer including ferromagnetic substance on said SUL.

6. A method of producing perpendicular magnetic recording media according claim 5 wherein each of said steps are executed successively in the vacuum.

7. A method of producing perpendicular magnetic recording media according claim 5, wherein
the step of heating said SUL and controlling the Fe nanocrystalline precipitated texture, and
the step of inducing an easy magnetization axis of a given direction in said SUL
are executed at the same time.

8. An apparatus of producing perpendicular magnetic recording media comprising a first depositing chamber for depositing a SUL on the substratum, an anisotropy control chamber disposed subsequently to said first depositing chamber for inducing an easy magnetization axis of a given direction in said SUL, and a second depositing chamber for depositing a perpendicular recording layer, where
a heating means for heating said substratum is provided between said first depositing chamber and said anisotropy control chamber or in said anisotropy control chamber, and
a magnetic field impressing means for inducing an easy magnetization axis of a given direction in said SUL is provided in said anisotropy control chamber.

9. A magnetic recording apparatus comprising a perpendicular magnetic recording medium according to claim 1, a driving part for driving said magnetic recording medium, and a magnetic head for recording and reproducing magnetic information wherein magnetic information is recorded and reproduced by means of said magnetic head on and from said magnetic recording medium as the latter moves therethrough.

10. A perpendicular magnetic recording medium according to claim 2, wherein
said SUL has a flatness of 1.0 nm or less in surface roughness for a film thickness range of 100 nm-500 nm.

11. A method of producing perpendicular magnetic recording media according claim 6, wherein
the step of heating said SUL and controlling the Fe nanocrystalline precipitated texture, and
the step of inducing an easy magnetization axis of a given direction in said SUL
are executed at the same time.
